(19) United States
(12) Patent Application Publication
(10) Pub. No.: US 2002/0046636 A1
(43) Pub. Date: Apr. 25, 2002

(54) High flow stringed instrument sound hole

(76) Inventor: Eric Thomas Schmidt, Wichita, KS (US)

Correspondence Address: Eric Thomas Schmidt, 524 Commerce, Wichita, KS, 67202, US

(21) Appl. No.: 09/969,235

(22) Filed: Oct. 2, 2001

Related U.S. Application Data
(60) Provisional application No. 60/237,623, filed on Oct. 3, 2000.

(51) Int. Cl. G10D 3/00

(52) U.S. Cl. 84/291

(57) ABSTRACT

Provision of venturi flange coupled with soundhole in resonant chamber of stringed musical instruments, to expand frequency and volume.

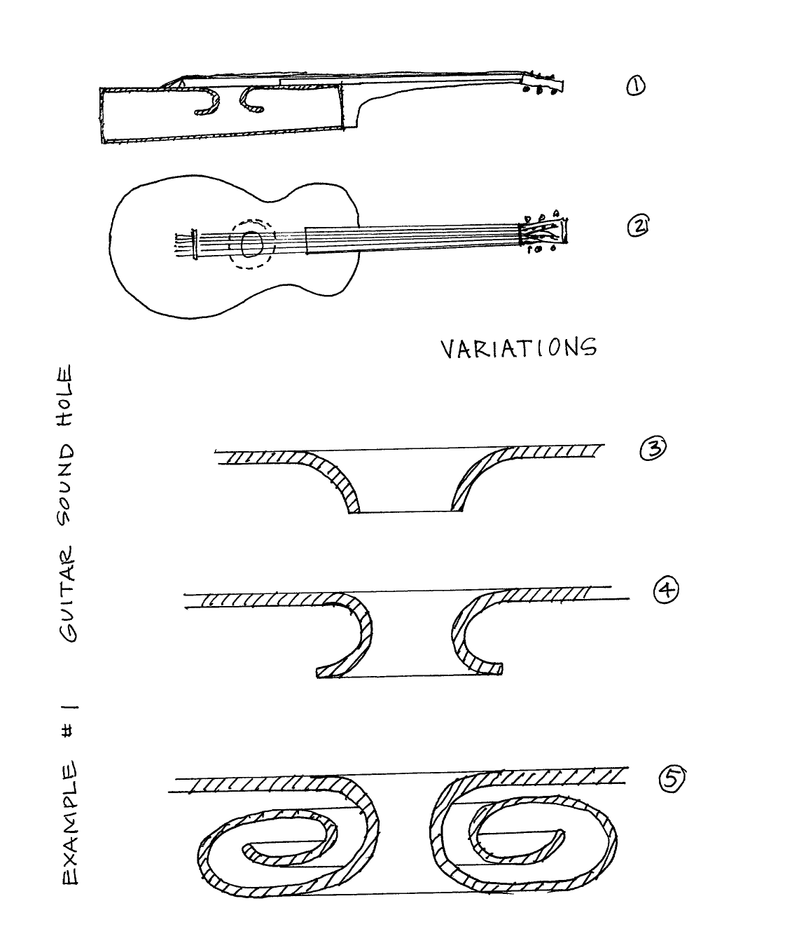

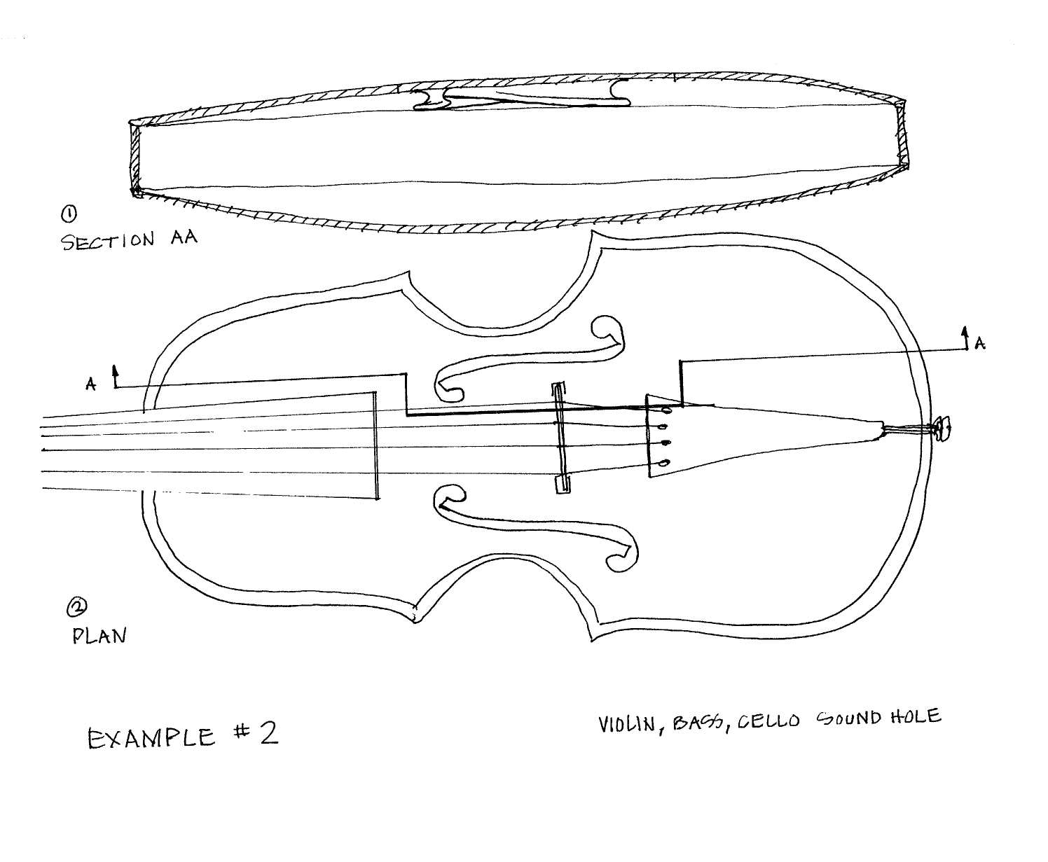

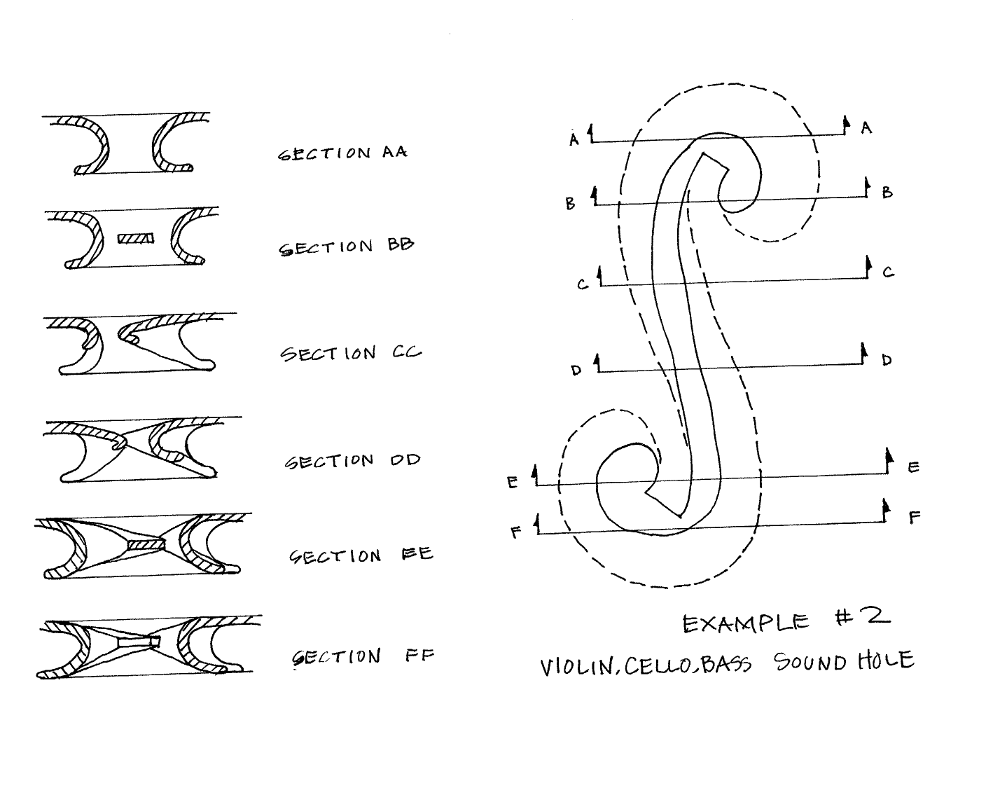

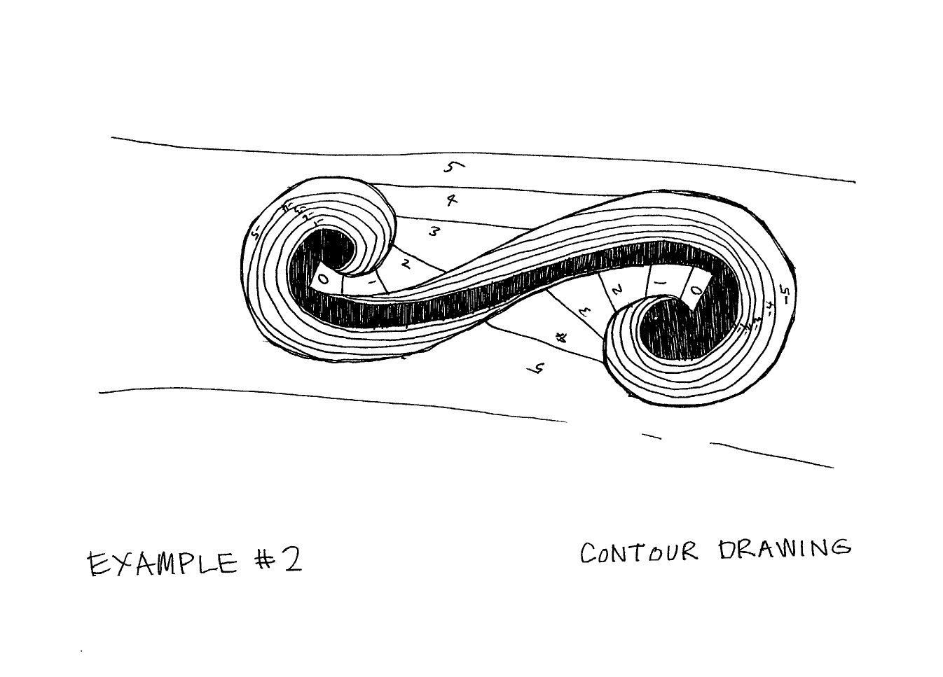

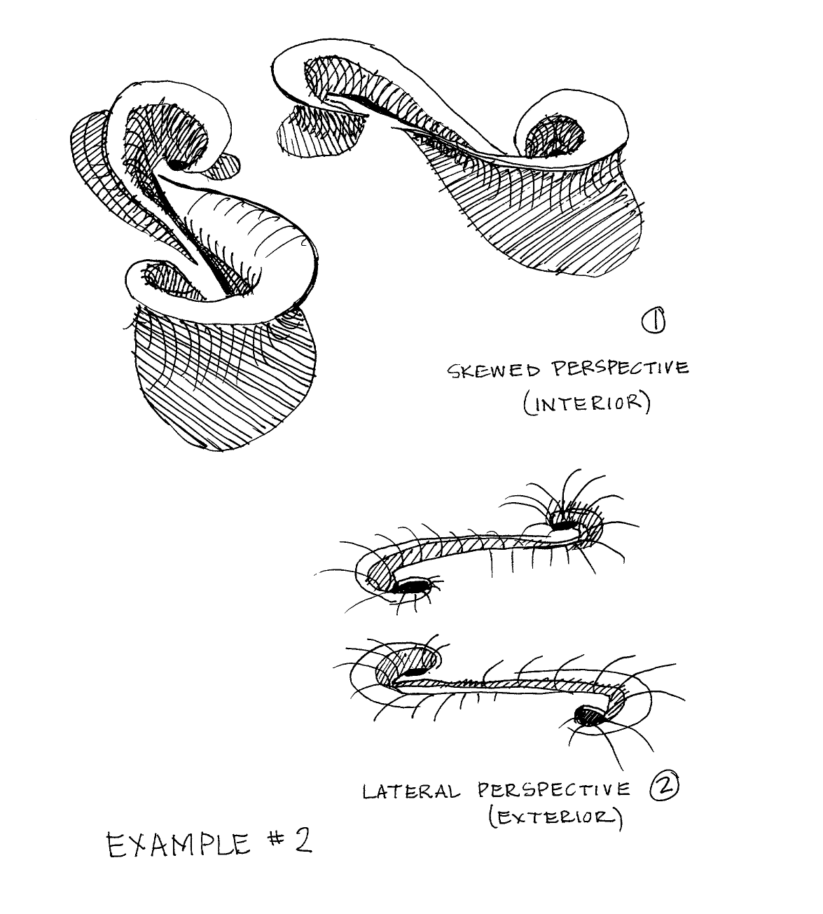

Provisional patent application No.: 60/237,623 Filing date: Oct. 3, 2000. Foreign filing license granted: Dec. 21, 2000

### BACKGROUND AND SUMMARY OF INVENTION

This invention pertains to stringed musical instruments with resonant chambers with sound holes or “f” holes. Stringed instruments transmit sound through air. Resonant chambers produce a barrier which isolates pressure waves in the air. String vibrations cause resonant chambers to cycle or vibrate, which results in movement of air through surface vibrations and movement of air through the sound hole or “f” hole. A prior art sound hole or “f” is a typical planar cutout, like a paper hole punch, strategically placed in the resonant chamber. Air-flow volume is limited by the edge of the “cut-out” sound hole or “f” hole, due to the lack of aerodynamic quality.

The high flow stringed instrument sound hole invention provides for a venturi flange, shaped according to the desired sound hole or “f” hole; Thus increasing capable air flow/volume. The length to which the flange divides the resonant chamber will affect the frequency response of the instrument.

The high flow stringed instrument sound hole invention will provide for the next level of refinement in the quality of the sound of musical instruments.

### EXPLANATION OF DRAWINGS

The five pages of drawings describe an example for guitar and an example for violin/bass/cello. The guitar sound hole is the most simple of stringed instruments, and the violin/bass/cello sound hole is of the most complex.Other stringed instruments with resonating chambers with sound holes lie in the middle of these extreme examples, all of which may be constructed but not limited to? carving in wood; casting in plastic-like material;spinning in fine sheet metal; pressing or molding from sheet material; etc . . . The High Flow Stringed Instrument Sound Hole may be incorporated in new instrument construction, or retrofitted to existing musical instruments.

### Sheet 1 of 5

1. This is a partial section of a guitar with a High Flow Stringed Instrument Sound Hole(HFSISH) incorporated with the interior of the resonating chamber of the stringed instrument.

2. This is a plan view of a guitar incorporating the HFSISH, denoted by the dashed line.

3 & 4. This is a section drawing of a variation of the HFSISH described in 1 and 2 above.

5. This is a section drawing showing a variation of the HFSISH. This variation shows the potential for effectively lowering the frequency of the instrument by effectively lengthening the inside of an instrument, isolating pressure waves, allowing for longer wave lengths.

### EXPLANATIONS OF DRAWINGS CONTINUED

### Sheet 2 of 5

1. This section drawing is of a violin, bass, or cello interior. This example of the high flow stringed instrument sound hole is far more complex than a round sound hole in a guitar. Drawing pages 3 through 5 will further explain this sound hole type.

2. This is a plan drawing of a violin/bass/cello associated with number 1 above.

### Sheet 3 of 5

This page shows multiple sections through a typical sound hole, with the high flow stringed instrument sound hole incorporated. Sections AA through FF show how a venturi is achieved throughout the traditionally shaped sound hole.

### Sheet 4 of 5

This drawing denotes contours given elevations, of no given unit, −5, −4, −3, −2, −1.0, 1, 2, 3, 4, 5, to show relative levels with regard to the three dimensional shape of the flange which creates the venturi.

### EXPLANATION OF DRAWINGS CONTINUED

### Sheet 5 of 5

1. This drawing attempts to show the viewer a three-dimensional massing of the high flow stringed instrument sound hole from the interior of the violin/bass/cello.

2. This perspective drawing of the exterior view of the violin/bass/cello sound hole demonstrates the fluid nature of the air traveling in and out of the sound hole with less resistance.

### A NOTE TO THE EXAMINER

The previous detailed written description and detailed mechanical drawings are derived from built instruments. If there is any question regarding writings or drawings, I will gladly furnish quality photographs to further explain this invention. Thank you for your time.

Eric Schmidt

524 Commerce

Wichita, Kans. 67202

316 263 6770

### DETAILED DESCRIPTION OF THE INVENTION

The High Flow Stringed Instrument Sound Hole is a venturi flange coupled with the sound hole of a resonating chamber of a stringed musical instrument. The strings of a musical instrument are typically plucked or bowed which initiates movement of said strings which are typically fixed to a more flexible, or drum-like surface of said resonating chamber. The energy transference from the vibrations of said strings to said resonating chamber produces a pressure differential in the air between the interior and the exterior of said resonating chamber to be equalized through said sound hole. Said equalization occurs diminishing amplitudes of pressure waves, which cycle in and out of said sound hole from several hundred times per second to several thousand times per second. With regard to a prior art sound hole, this rapid movement of air is tragically ruffled by the harsh edge of the typical planar cut-out. The provision of said venturi flange overcomes drag produced by said edge, resulting in increased velocity of air movement through said High Flow Stringed Instrument Sound Hole.

With regard to production of said High Flow Stringed Instrument Sound Hole, manufacture by, but not limited to:

1) carving or machining wood, plastic, metal, etc . . .

2) cast plastic material

3) spinning fine sheet metal

4) pressing or molding sheet material

5) etc . . .

Said High Flow Stringed Instrument Sound Hole may be incorporated in new instrument construction, or retrofitted to existing musical instruments.

What I claim as my invention is:

1. A venturi flange coupled with the sound hole or “f” hole in the resonant chamber of a stringed musical instrument.

2. The venturi flange in accordance with claim 1, varies in size and shape to meet desired volume and frequency in accordance with resonant chamber in claim 1.
